(19) United States
(12) Patent Application Publication
(10) Pub. No.: US 2008/0240653 A1
(43) Pub. Date: Oct. 2, 2008

(54) OPTICAL COUPLER INCLUDING MODE-MIXING

(76) Inventors: Jonathan Paul King, San Francisco, CA (US); Paul Chetwode Abrahams, Fremont, CA (US); Gayle L. Noble, Boulder Creek, CA (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/739,048

(22) Filed: Apr. 23, 2007

Related U.S. Application Data
(60) Provisional application No. 60/908,396, filed on Mar. 27, 2007.

(51) Int. Cl. G02B 6/26

(52) U.S. Cl. 385/28

(57) ABSTRACT

A mode-mixer is used to introduce mode-mixing to an input in an optical coupler. As a result, modal noise effects are minimized in an output of the optical coupler. An example of a mode-mixer implemented includes a step index optical fiber which may or may not be coupled to a graded index optical fiber via a splice within an optical coupler. The splice may be a mechanical splice using connectors or a fused splice in some embodiments. The optical coupler may be included in a system for monitoring and/or analyzing a network.

### CROSS-REFERENCE TO RELATED APPLICATIONS

This application claims the benefit of U.S. Provisional Application No. 60/908,396 filed Mar. 27, 2007, the contents of which are hereby incorporated by reference herein.

### BACKGROUND

Monitoring and analysis of data networks transmitting and receiving data at high data rates necessitates the ability to access the network data stream without disrupting data transmission or the operation of the network. To this end, monitoring systems utilizing network taps are employed which are configured so that network data can be captured for analysis without compromising the operation of the network. In multimode fiber networks, an optical coupler can be used to tap off a fraction of optical energy from a signal in the main transmission path. Such tapped fraction may be received by an optical receiver and data processor to enable signal quality analysis and fiber link monitoring.

Optical couplers should have low loss in the main output to minimize degradation to the main signal. In addition, due to decreased loss budget at higher data rates, optical couplers are required to divert a lower fraction of optical energy at the higher data rates. Such optical couplers are referred to herein as “high split ratio optical couplers” due to a high fraction of optical energy retained in the main output. Finally, as data rate increases, bit-period decreases. The decrease in bit-period corresponds with increased effects of signal degradation.

The sum of all of these effects is that conventional multimode optical couplers do not work reliably at high bit rates (e.g. at least as high as 4 gigabits-per second (Gbps)). Thus, as data rates increase, several constraints create an obstacle for conventional optical couplers to provide reliable access to a network data stream without compromising data transmission and the operation of the network.

### BRIEF SUMMARY OF SEVERAL EXAMPLE EMBODIMENTS

An optical coupler is disclosed. The optical coupler includes an input and means for introducing mode-mixing. The optical coupler further includes a first output, a second output, and a fiber optic splitter. The fiber optic splitter is configured to optically couple the input with the first output and the second output.

A system is disclosed. The system includes an optical coupler. The optical coupler includes an input and means for introducing mode-mixing. The optical coupler further includes a first output, a second output, and a fiber optic splitter. The fiber optic splitter is configured to optically couple the input with the first output and the second output. The system further includes a first electronic device optically coupled to the input of the optical coupler. The system further includes a second electronic device optically coupled to the second output of the optical coupler.

A method for processing an optical signal transmitted in an optical communication link is disclosed. The method includes introducing mode-mixing to the optical signal and diverting a portion of the mode mixed optical signal.

These and other aspects of the present invention will become more fully apparent from the following description and appended claims.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B are eye diagrams illustrating the increase in signal degradation of a 30 percent tap output as data rate is increased from 2 Gbps (FIG. 1A) to 4 Gbps (FIG. 1B);

FIGS. 2A, 2B, and 2C are images of eye diagrams illustrating the difference in signal degradation between an optical coupler without mode-mixing (FIG. 2B) and an optical coupler including mode-mixing (FIG. 2C);

FIGS. 3A and 3B are eye diagrams illustrating the relative increase in jitter as bit rate increases;

FIG. 4 discloses an example of an optical coupler;

FIGS. 5A and 5B illustrate cylindrical modes within an optical fiber before mode mixing (FIG. 5A) and after mode-mixing (FIG. 5B);

FIG. 6 discloses an example of an optical coupler;

FIG. 7 discloses an example of an optical coupler;

FIG. 8 discloses an example of a high density tap including multiple optical couplers;

FIG. 9 discloses an example of a system for monitoring an optical link; and

FIG. 10 discloses an example of a method for processing an optical signal.

### DETAILED DESCRIPTION OF SEVERAL EMBODIMENTS

Conventional optical couplers fail to address the distribution of modes within an optical fiber. Modes are the various possible patterns of standing or propagating electromagnetic fields in an optical fiber. Modes are characterized by their wavelength, the spatial distribution and direction of their electric and magnetic field components relative to the boundaries of the optical fiber, and the field strengths of these components.

As optical coupler split ratios increase, the probability of modal noise in a low fraction tap output increases dramatically. Modal noise results from a loss of power in one or more modes of an optical signal when the optical signal is split between a high fraction main output and a low fraction tap output of an optical coupler. This modal noise manifests itself as increased jitter in the low fraction tap output, although such jitter is typically not representative of the signal in the large fraction main output.

As disclosed herein, mode-mixing is introduced to an input optical signal to an optical coupler in order to decrease modal noise in the tap output. Mode-mixing relates to the transfer of power among modes to provide a desired modal distribution within the optical fiber. As used herein, any device(s) capable of performing mode-mixing are described herein as a “mode-mixer”. Moreover, as used herein, the terms “tap” or “optical tap” can refer to one or more optical coupler(s). Thus, the terms “tap,” “optical coupler,” “optical tap,” and “optical tap coupler” may be used interchangeably.

A result of this mode-mixing is that modal noise is reduced in the tapped output such that the waveform of the tap output signal more closely resembles the waveform of the input optical signal. This effect is particularly beneficial in high split ratio optical coupler applications. Therefore, the optical couplers disclosed herein provide more reliable access to a network data stream for analysis or other purposes without compromising data transmission and the operation of the network.

To better understand the importance of modal distribution to high split ratio optical couplers, what follows is a brief discussion of (1) the relation of optical loss budget to split ratio, (2) the relation of split ratio to modal noise, and (3) the relation of data rate to signal degradation such as jitter, followed by a discussion of several examples of (4) optical couplers and (5) systems and methods incorporating the optical couplers, which reflect various aspects of the invention.

I. The Relation of Optical Loss Budget to Split Ratio

Often, the amount of permissible optical loss in a component or system is defined in terms of an optical loss budget. In an optical communication system, loss is the amount of optical power or energy consumed in a circuit or component, usually expressed in decibels (dB). The optical loss budget includes the allocation of the total permissible loss among the components of a system, such as cables, couplers, and splices, such that the system is designed for minimum cost at tolerable bit-error ratios. Required transmitter power, receiver sensitivity, intervening losses, and power margins are all considered in the loss budget.

As data rates increase in fiber optic data transmission systems, the optical loss budget decreases. As a result, a relatively smaller portion of the optical loss budget may be allocated to the tap output of an optical coupler. Thus, in such high speed applications, optical couplers with higher split ratios are required.

In high split ratio optical couplers, the larger number refers to the fraction of optical energy coupled to the main output of the optical coupler and the smaller number refers to the fraction of optical energy coupled to the tap output of the optical coupler. For example, high split ratio optical couplers associated with split ratios of 70:30, 80:20, or higher may be required instead of a 50:50 split ratio, so that less optical energy is diverted from the main output.

The loss budget of a given link generally dictates the selection of the split ratio of an optical coupler for use in an optical link. There are a variety of ways the loss budget for a Fibre Channel link can be calculated. One way is to identify a theoretical loss budget from a specification. For example, the specification of channel insertion loss for a 50 micrometer 2000 MHz-km multimode fiber is illustrated by Table 2 below.

TABLE 2

| Fibre Channel Bit Rates (Gbps) | Theoretical Channel Insertion Loss (dB) |
|---|---|
| 1.0625 | 4.62 |
| 2.125 | 3.31 |
| 4.25 | 2.48 |

Moreover, main channel and tap channel attenuation may be considered as illustrated by the Table 3 shown below for different tap split ratios.

TABLE 3

| | Line Side | Tap Side |
|---|---|---|
| MM Tap Ratio | Attenuation (max) dB | Attenuation (max) dB |
| 90:10 | 1.3 | 10.8 |
| 80:20 | 1.9 | 8 |
| 70:30 | 2.5 | 6.3 |
| 60:40 | 3.2 | 4.9 |
| 50:50 | 4 | 4 |

Thus, by comparing the theoretical channel insertion loss (2.48 dB from Table 2) for a 4.25 Gbps link, for example, to the line side attenuation in a given tap (second column of Table 3), it can be determined that the tap should have a split ratio no higher than 70:30 in some embodiments. Thus, in high data rate applications, the decrease in optical loss budget often necessitates the use of high split ratio optical couplers.

II. The Relation of Split Ratio to Modal Noise

As optical coupler split ratios increase, the probability of modal noise increases in the tap output of an optical coupler that does not employ mode mixing. For example, an optical coupler having a 50:50 split ratio will have a lower probability of modal noise than an optical coupler having a 70:30 split ratio or higher. The example shown in Table 4 below illustrates the effect of modal noise (exhibited as induced jitter) as bit rate increases.

TABLE 4

| Fibre Channel Bit Rates | Bit Period | Jitter 80 ps - Eye Closure |
|---|---|---|
| (Gbps) | (Picoseconds) | Penalty |
| 1.0625 | 941 | 8.50% |
| 2.125 | 471 | 17.00% |
| 4.25 | 235 | 34.00% |
| 8.5 | 118 | 68.00% |

Thus, at lower data rates, the percentage of eye closure may be tolerable. However, at bit rates of 4.25 Gbps and 8.5 Gbps, for example, the jitter shown in Table 4 begins to severely impact system performance.

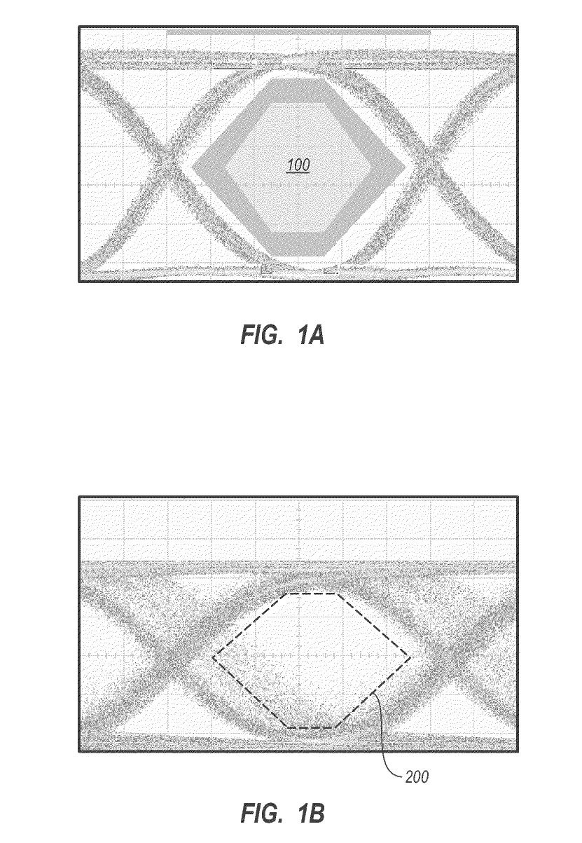

Referring to FIG. 1A, an image of an eye diagram is illustrated representing an optical signal for a tap output of a 70:30 optical coupler at 2 Gbps without mode-mixing. As shown, a mask margin test is still quite acceptable as substantially all of the sample points of the eye diagram lie outside of a superimposed mask 100. On the other hand, by increasing the bit rate (decreasing the bit period) in the fiber optical coupler to 4 Gbps without introducing mode-mixing, the associated jitter in the eye becomes more dominant and many points are sampled well within the eye and a boundary of where a superimposed mask would lie as shown by dotted lines 200 in FIG. 1B. The increase in jitter clearly apparent by a comparison of FIGS. 1A and 1B is not, however, an accurate representation of the signal in the main output which experiences a low portion of the degradation shown in FIG. 1B due to the corresponding increase in data rate. Further discussion regarding the relation of jitter to modal noise is provided below in section III.

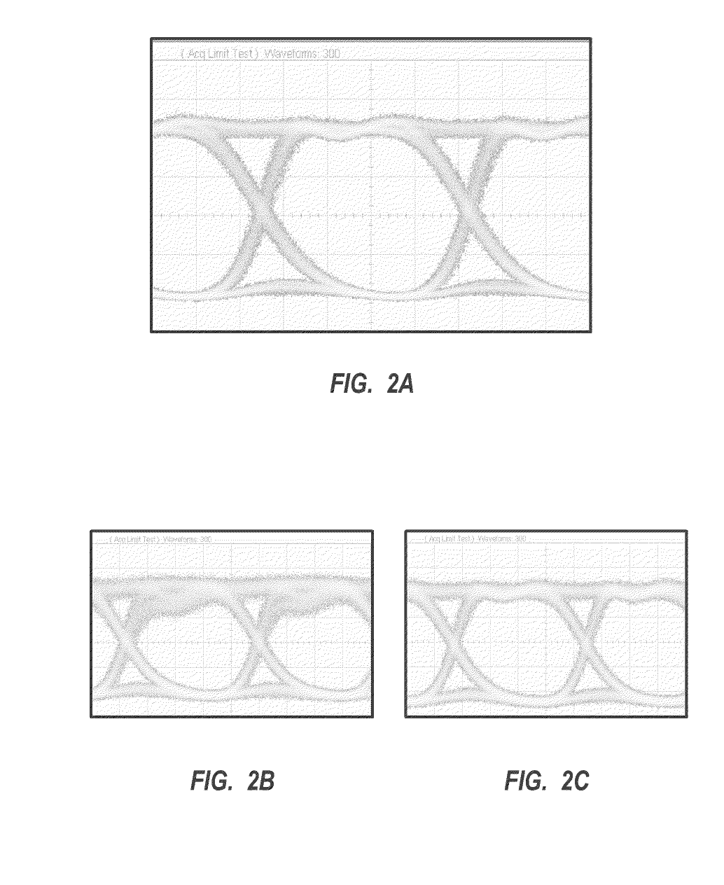

Introducing mode-mixing to optical signals substantially decreases signal degradation introduced in the tap output of split ratio optical couplers operating at high data rates. For example, referring to FIG. 2A, an image of an eye diagram sampled for a 4 Gbps input optical signal to an optical coupler is illustrated. As shown in FIG. 2A, the input optical signal is characterized by a substantially open eye with minimal jitter and signal distortion. In general, the eye diagram associated with a tap output of the optical coupler should resemble the eye diagram of the signal shown in FIG. 2A as closely as possible.

FIG. 2B is an image of an eye diagram representing the optical signal of a tap output of a 70:30 split ratio optical coupler without mode-mixing. FIG. 2C depicts an image of an eye diagram representing the optical signal of a tap output of a 70:30 split ratio optical coupler incorporating mode-mixing. As can be appreciated from a comparison of FIGS. 2B and 2C, the tap output eye diagram of FIG. 2C more closely resembles the input optical signal eye diagram of FIG. 2A than does the tap output eye diagram of FIG. 2B. Thus, according to the embodiments disclosed herein, signal integrity is greatly enhanced in the tap output of optical couplers by introducing mode-mixing to optical signals.

Moreover, improvements are also realized at line speeds higher than 4 Gbps. In one trial, the tapped signal in a 70:30 split ratio optical coupler operating at about 10 Gbps using 20 centimeters of step index optical fiber (also used to generate the eye diagram shown in FIG. 2C at 4 Gbps) revealed the improvements shown in Table 5 below.

TABLE 5

| | 70% Output | 30% Output | Input to Tap |
|---|---|---|---|
| Without Mode-Mixing | | | |
| Jitter (rms) | 3.23 ps | 4.35 ps | 3.32 ps |
| Mask Margin | 28% | −30% | 30% |
| With Mode-Mixing | | | |
| Jitter (rms) | 3.28 ps | 3.8 ps | 3.17 ps |
| Mask Margin | 24% | 15% | 27% |

In the 10 Gbps example shown in Table 5, the mask margin in the 30 percent tap output improved from −30 percent to +15 percent with the introduction of mode-mixing. Thus, introduction of mode-mixing at 10 Gbps data rates reduces modal noise manifested by increased jitter as well as at 4 Gbps.

III. The Relation of Data Rate to Signal Degradation

As discussed above, modal noise is exhibited as increased jitter in the tap output of high split ratio optical couplers, which is not exhibited in the input optical signal. However, at high data rates, jitter also becomes more pronounced at least due to decreased bit period. Therefore, as data rates increase, reducing jitter due to modal noise becomes increasingly important.

Jitter is the deviation from ideal timing of a data signal, and is typically measured from the zero-crossing of the data signal. In other words, jitter indicates the deviation of pulses from their ideal position in time. One method for demonstrating the extent of jitter includes the generation of eye diagrams. An eye-diagram typically displays multiple waveform crossings simultaneously on an overlaid time base. Eye diagrams present a measurement of total jitter (deterministic and random jitter combined) and extinction ratio (ratio of average high to average low logic level). An eye-diagram is also used to provide a visual representation of whether a link meets an eye-diagram test specification for a given standard, such as the Fibre Channel-Generic Services 4 (FC-GS-4) (2004) standard, for example, the contents of the FC-GS-4 standard are hereby incorporated by reference herein.

Modern sampling oscilloscopes can display the jitter histogram at the threshold crossing and can generate a “mask” to spot jitter violations. A jitter violation may be identified by an unacceptable number of samples recorded within the perimeter of the mask. However, to satisfy a specification, the sampled pulse typically must remain entirely outside of the mask.

As bit rate increases, sensitivity to induced jitter from modal noise also increases. As illustrated by Table 6 shown below, as bit rate increases, bit period decreases proportionally.

TABLE 6

| Fibre Channel Bit Rates Gbps | Bit Period (Picoseconds) |
|---|---|
| 1.0625 | 941 |
| 2.125 | 471 |
| 4.25 | 235 |
| 8.5 | 118 |

The reduction in bit period results in a corresponding reduction of eye width in an eye diagram. Therefore, the corresponding reduction of eye width due to reduced bit period contributes to an increased risk of jitter violations due to modal noise.

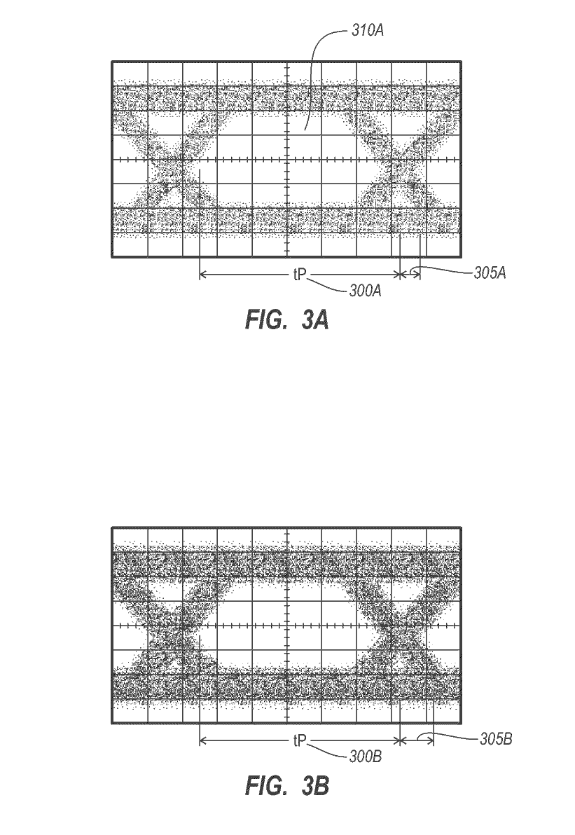

For example, referring to FIG. 3A, a representation of an eye diagram characterizing a data signal transmitted at a first data rate is illustrated. Three time periods, tP 300A, of the main system clock are depicted. In FIG. 3A, jitter is represented by the width 305A of the walls of the eye. As jitter increases, the space 310A in the center of the eye diagram (including eye width) decreases. Eye width is a good measure of the stability of a data channel.

As data rates increase, timing accuracy becomes more critical to system performance. This is because the magnitude of jitter measured in seconds may be roughly unchanged, but measured as a fraction of bit period, jitter increases proportionally with the data rate and causes errors. Thus, an amount of jitter that is allowable at a lower data rate may be unacceptable at a relatively higher data rate.

FIG. 3B illustrates an eye diagram representing a signal transmitted at twice the data rate of the signal represented by the eye diagram shown in FIG. 3A. For example, FIG. 3A may represent a signal transmitted at 2 Gbps and FIG. 3B may represent a signal transmitted at 4 Gbps. As shown in FIG. 3B, the jitter 305B per bit-period has increased due to the increase of data rate and corresponding reduction in time period tP 300B. Therefore, the amount of jitter 305B compared to eye width increases proportionally with the data rate, and causes a higher likelihood that a receiver will make an error in detecting the presence or absence of a pulse.

IV. Mode-Mixing Optical Coupler Examples

A mode-mixer is used to improve modal distribution in an optical coupler. The improved modal distribution results in reduced modal noise exhibited by reduced jitter in the tap outputs of high split ratio optical couplers. As a result, the tap output more accurately represents the waveform of an optical signal transmitted in the main output (although at a lower level of power in high split ratio embodiments). Therefore, a reliable tap output signal is provided for monitoring and analysis of a network data stream without compromising data transmission or the operation of the network

Mode-mixing can also be used to provide a modal distribution that is independent of source characteristics. The modal noise in optical couplers without mode-mixing is also affected by the mode launch pattern of the optical energy into the fiber, the manner in which the modes propagate through the fiber, and the splicing technique used in the fiber optic splitter. For example, modal distribution may depend on the type of source, such as type of laser or light emitting diode, generating the signal. Moreover, modal distribution may be affected by the quality of optical components, such as the quality of the optical source, optical fiber, optical splice, or optical connection. Mode-mixing compensates for different modal distributions caused by different source characteristics and component quality by mixing the modes within the input optical signal such that modal noise is reduced in tap outputs irrespective of the effects of optical source type or quality of optical components.

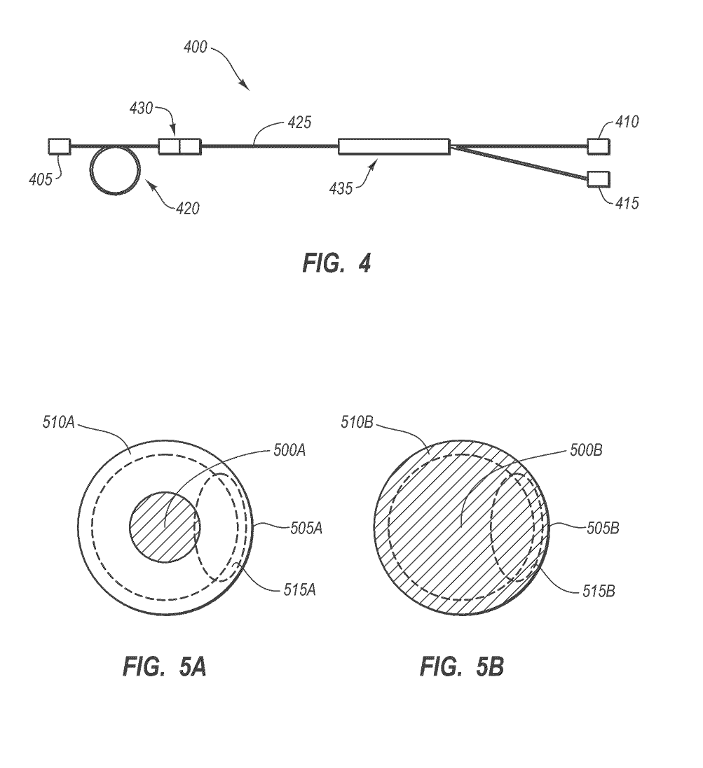

Referring to FIG. 4, an optical coupler 400 is illustrated which includes an input 405 coupled to a first output 410 and a second output 415 by a fiber optic splitter 435. The optical coupler 400 further includes means for introducing mode-mixing. In this example, the means for introducing mode-mixing is implemented as a length of step index optical fiber 420 optically coupled to the input 405. The optical coupler 400 further includes means for coupling optical energy that optically couples the step index optical fiber 420 to a graded index optical fiber 425. In the embodiment illustrated in FIG. 4, the means for coupling optical energy is implemented as a mechanical splice 430. The mechanical splice 430 can include a mated plug assembly between the step index optical fiber 420 and the graded index optical fiber 425 of the optical coupler 400. In some embodiments, the mated plug assembly 430 is implemented using industry standard connectors, such as LC type optical connectors.

The fiber optic splitter 435 splits an input optical signal between the first output 410 and the second output 415 by some relative percentage (split ratio) of optical energy. In some embodiments, the portion of optical energy coupled to the first output 410 can be between about 10 and about 50 percent of the total optical energy of the input signal. According to other embodiments, about 20 percent or about 30 percent of the total optical energy of an input optical signal is diverted to the first output 410. The scope of the invention is not, however, limited to these examples of split ratio.

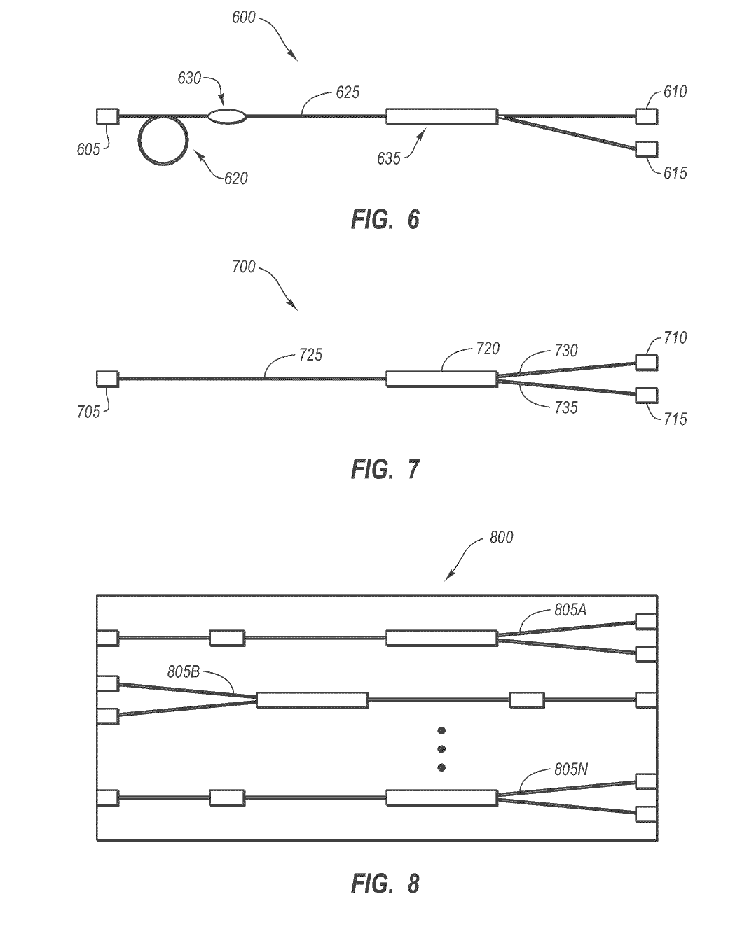

The length of the step index optical fiber 420 may be determined by taking into consideration the modal dispersion of the step index optical fiber 420 and the highest bit rate to be transmitted. However, the length of the step index optical fiber 420 may alternatively be substantially independent of bit rate. That is, one length of step index optical fiber 420 can perform sufficient mode-mixing for a wide range of bit rates, for example bit rates of 4, 8, or 10 Gbps, or higher. However, the length of the step index optical fiber 420 may have an associated minimum value necessary to introduce sufficient mode-mixing, or limited by a manufacturing process, such as a minimum length required for a fusion splice as discussed below with reference to FIG. 6.

The step index fiber 420 can have any combination of length, diameter, and numerical aperture (NA) attributes. For example, the length of the step index optical fiber 420 can be at least about 2 centimeters, between about 5 and about 100 centimeters, or between about 10 centimeters and about 20 centimeters (about 8 inches). The diameter of the step index optical fiber 420 can be at least 25 micron, less than 200 micron, about 50 micron, or about 62.5 micron. The diameter can also be selected to provide improved coupling (least power loss) in a splice between the step index optical fiber 420 and the graded index optical fiber 425. The NA of the step index optical fiber 420 can be about 0.2, for example. In each example, the length, diameter, and NA of the step index fiber 420 can be selected such that the optical coupler 400 can transmit data received by the input 405 to the first output 410 and the second output 415 while sufficiently introducing mode-mixing to the input signal.

Referring to FIG. 5A, a representative distribution of cylindrical transverse modes 500A within an optical fiber 505A is illustrated as that distribution may appear prior to performance of a mode-mixing process. Use of cylindrical transverse modes is illustrated by example for a simplified understanding of one type of mode which may be affected by the mode-mixer, although other types of modes may receive similar benefits according to the teachings disclosed herein.

In this example, the modes 500A are generally distributed within a central portion of the optical fiber 505A as shown. Thus at least a portion of the modes 500A may not be coupled to a tap output of an optical coupler depending on which portion of the optical energy is diverted to the tap output. For example, as shown in FIG. 5A, if optical energy from an outer periphery 510A of the optical fiber 505A is diverted to a tap output of an optical coupler, the modes 500A may not be properly coupled to the tap output. As a second example, if optical energy from a lateral portion 515A within the optical fiber 505A is diverted to a tap output of an optical coupler, only a small portion of the modes 500 may be coupled to the tap output of the optical coupler. The variation of the modal loss (for example due to fiber layout, source wavelength, etc.) is exhibited as the induced jitter.

Referring to FIG. 5B, however, a representation of mixed modes 500B is illustrated after mode-mixing to the modes 500A has been performed. As shown in FIG. 5B, the mixed modes 500B more fully fill the optical fiber 505B. As discussed herein, such modal distribution in an optical fiber is of increased importance to optical coupling as rates of optical data transmission increase requiring higher split ratio optical couplers. For example, as can be appreciated from a comparison of FIG. 5A to FIG. 5B, if optical energy from an outer periphery 510B or from a lateral portion 515B is diverted from the optical fiber 505B to a tap output of an optical coupler there is less likelihood of modal loss after mode-mixing as the modes 500B more fully fill the cross section of the optical fiber 505B. While FIG. 5B illustrates a substantially mode-filled optical fiber 505B, it should be appreciated that any change in modal distribution which improves coupling of modes to a tap output of an optical coupler is included within the teachings herein.

In one test comparing the results of a 80:20 split ratio optical coupler according to the example illustrated in FIG. 4, a 131% improvement in percent of mask margin was realized at 4 Gbps with the introduction of mode-mixing. More specifically, −97 percent mask margin was recorded using the optical coupler without mode-mixing. However, a +34 percent mask margin was realized using the optical coupler incorporating mode-mixing. Moreover, after connecting the optical coupler to a Bit Error Rate Test (BERT) device, no errors were identified after 46 hours of testing the 4 Gbps tapped optical signal.

Referring to FIG. 6, an optical coupler 600 is illustrated according to an example embodiment. The optical coupler 600 illustrated in FIG. 6 is similar to the optical coupler 400 illustrated in FIG. 4 in that the optical coupler 600 includes an input 605, first output 610, second output 615, step index optical fiber 620, graded index optical fiber 625, and a fiber optic splitter 635. However, according to the embodiment illustrated in FIG. 6, the means for coupling optical energy between the step index optical fiber 620 and the graded index optical fiber 625 is implemented as a fusion splice 630. A fusion splice is a fiber optic splice made by applying sufficient heat to melt, fuse, and thus join an end from each of two lengths of optical fiber in order to form a single optical fiber with low, if not near-zero, attenuation at the fusion splice. Any other type of splice may be implemented, such as an ultraviolet cured or bonded splice, a rotary mechanical splice, or a ribbon splice.

It should be appreciated, however, that some elements of the embodiments disclosed herein can be omitted and/or substituted. For example, other means for introducing mode-mixing may be implemented. Certain attenuation devices, surface coatings, finishes, mechanical or optical perturbations, and other types of optical fiber may also introduce mode-mixing. For example, in some embodiments a doped fiber is used in place of, or in addition to, the step index fiber to introduce mode-mixing. According to another example, mode-mixing is introduced by applying a surface finish to an input of an optical coupler by deposition techniques, or by introducing a controlled amount of roughness to the surface finish. These various embodiments can also have the effect of introducing mode-mixing.

However, use of a graded index fiber may be more reliable in some applications. Moreover, use of a graded index fiber does not introduce substantial attenuation or signal degradation that may be adverse in some applications. Thus, while some embodiments may exhibit advantages over other embodiments in some applications, any means for introducing mode-mixing in an optical coupler may be implemented according to the teachings disclosed herein.

As another example, the graded index optical fiber may be eliminated where not needed for the functionality of the fiber optic splitter. For example, referring to FIG. 7, an optical coupler 700 is illustrated according to an example embodiment. The optical coupler 700 includes an input 705, first output 710, second output 715, and a fiber optic splitter 720. However, in this embodiment, an entire input optical fiber 725 is a step index optical fiber. Thus, the means for coupling optical energy between a step index optical fiber and a graded index optical fiber at the input is omitted in this example. Moreover, a graded index fiber is omitted from the input fiber 725. However, a graded index fiber may be optically coupled to the input fiber 725 from external to the optical coupler 700, for example by a mated plug assembly.

In one embodiment, a first output optical fiber 730 and a second output optical fiber 735 each include, or consist of, a step index fiber. According to another embodiment, only one of the first output optical fiber 730 or the second output optical fiber 735 includes, or consists of, a step index fiber. For example, in one embodiment, the second output optical fiber 735 is a main output of a high split ratio optical coupler and includes a step index fiber, whereas the first output optical fiber 730 is a tap output of the optical coupler and includes a graded index fiber.

An optical coupler may also include a housing within which the optical couplers of FIGS. 4, 6, and/or 7 are contained. As a consequence of such housing, consumer tampering with the various elements may be substantially prevented by a manufacturer. In another embodiment, the graded index optical fiber and fiber optic splitter may be contained within a housing and the step index optical fiber may be external to the housing but coupled to the graded index optical fiber via a connector, such as an LC type connector. Thus, a step index optical fiber patch cord may by used to introduce mode-mixing to the input of an optical coupler via a connection there between.

V. Systems and Methods Implementing Mode-Mixing Optical Couplers

The optical couplers disclosed in FIGS. 4, 6, and/or 7 can be incorporated into a high density optical tap system. For example, referring to FIG. 8, a high density optical tap 800 can include a plurality of optical couplers 805A-N, such as the optical couplers disclosed in FIGS. 4, 6, and/or 7. In one embodiment, high density optical tap 800 can include between about 4 and 32 optical couplers 805A-N. The optical couplers 805A-N may be disposed in the same direction, opposing directions, or a combination thereof. One example of a high density optical tap, which can incorporate the optical couplers disclosed in FIGS. 4, 6, and/or 7, is the High Density TAP manufactured by Finisar Corporation of Sunnyvale, Calif. Such high density tap embodiments may include fault-tolerant TAPs (Traffic Access Points) which provide access to storage traffic from both sides of a full-duplex link at line rate speed. Such high density tap embodiments can be substantially non-intrusive to storage networks (or other networks) and provide a way to access Fibre Channel traffic for monitoring, analysis and diagnosis. Such high density tap embodiments may minimize space occupied in a chassis with 16 single TAPs in a 1 U rack mountable configuration. The optical couplers in the high density tap can be available in 62.5 or 50 micron version fibers with optical split ratio choices of 50:50, 70:30, or 80:20, for example.

The optical couplers of FIGS. 4, 6, and 7 can be used to tap off a fraction of optical power from an optical link. The tapped optical power may be received by an optical receiver and data processor, to allow signal quality and fiber link monitoring. Thus, the optical couplers of FIGS. 4, 6, and 7 may be part of a fiber link monitoring and analysis system that includes a network analysis device.

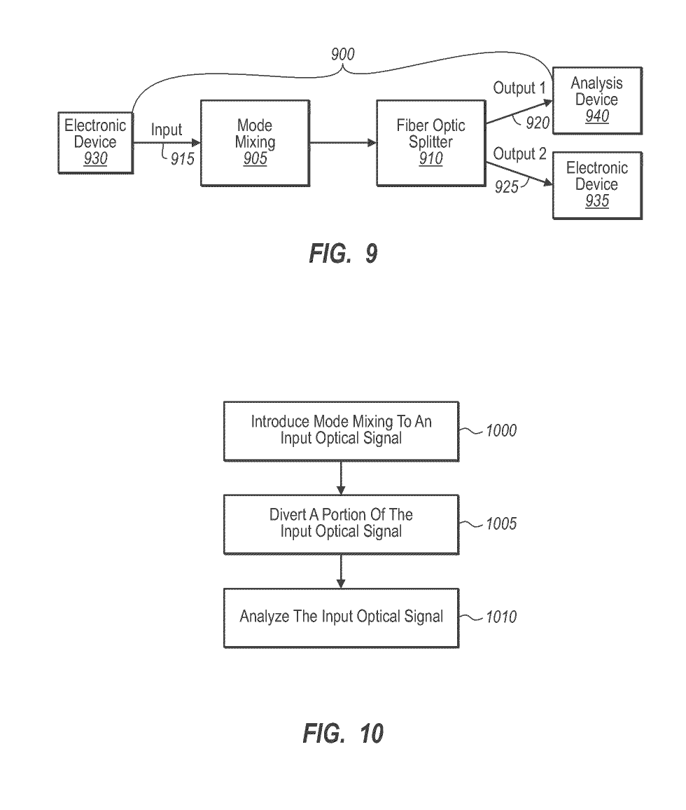

FIG. 9 illustrates an example of a system for monitoring an optical link. The system includes an optical coupler 900. The optical coupler 900 includes means for introducing mode-mixing 905. The optical coupler 900 further includes a fiber optic splitter 910. The optical coupler 900 includes an input 915, a first output 920, and a second output 925. The input 915 is optically coupled to both the first output 920 and the second output 925 such that data signals received by the input 915 are transmitted to the outputs 920 and 925.

The system further includes a first electronic device 930 optically coupled to the input 915 of the optical coupler 900. The system further includes a second electronic device 935 coupled to the second output 925 of the optical coupler 900. In one embodiment, the first electronic device 930 includes a network host device and the second electronic device 935 includes a network switch device, or vice-versa, depending on the network link to which the optical coupler 900 is coupled.

The system further includes an analysis device 940 coupled to the first output 920. The analysis device 940 may be configured to monitor and/or analyze data transmitted from the first electronic device 930 to the second electronic device 935 at line rates of at least 2, 4, 8, and/or 10 Gbps. One example of such an analysis device 940 is the Netwisdom Probe manufactured by Finisar Corporation of Sunnyvale, Calif. The analysis device 940 can be connected to the link of a network through the use of the optical coupler 900. In this way, the analysis device 940 can gather all of the transactions at the Initiator/Target/LUN level (host to storage conversations) and provide detailed statistics on network health and performance. Input 915 may be coupled to a Fibre Channel link (or other type of link) within a network, such as a storage area network (SAN). The electronic devices 930, 935 and/or analysis device 940 can include testing equipment such as a BERT device, oscilloscope, signal generator, or other electronic testing devices.

Referring to FIG. 10, a method for processing an optical signal is illustrated. The method includes introducing mode-mixing to an input optical signal transmitted in the optical communication link (1000). The method further includes diverting a portion of the input optical signal from the optical communication link (1005) after the mode-mixing is introduced to the input optical signal (1000).

The method further includes performing analysis of the input optical signal (1010). The analysis can include a determination of mask margin associated with the input optical signal. The analysis can also include determination of less than 5 percent increase in mask hits (mask degradation) associated with diversion of the portion of the input optical signal from the communication link. The analysis can also include performance analysis of a network within which the input optical signal is transmitted.

The diverted portion of the input optical signal can be output to a passive or active optical device. For example, the diverted portion of the input optical signal can be output to an optical receiver which converts the diverted portion of the input optical signal to an electrical signal. The electrical signal, or a result of the analysis, may be output to an electronic device. Examples of such electronic devices include a computer, display, printer, network switch, router, modem, physical storage medium, data processing device, probe, network analysis device, network test device, BERT device, oscilloscope, or other electronic device, whether located locally or over a network.

It should be understood that the drawings are diagrammatic and schematic representations of such example embodiments and, accordingly, are not limiting of the scope of the present invention, nor are the drawings necessarily drawn to scale. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Detailed descriptions of apparatus and processing techniques known in the field of the invention to one of ordinary skill in the art have been excluded.

1. An optical coupler comprising:
an input;
means for introducing mode-mixing optically coupled to the input;
a first output;
a second output; and
a fiber optic splitter configured to optically couple the input with the first output and the second output.

2. An optical coupler according to claim 1, wherein the means for introducing mode-mixing includes a step index optical fiber.

3. An optical coupler according to claim 2, wherein the input includes a graded index optical fiber, wherein the input further includes means for coupling optical energy between the step index optical fiber and the graded index optical fiber.

4. An optical coupler according to claim 3, wherein the means for coupling optical energy includes an optical fiber splice between the step index optical fiber and the graded index optical fiber.

5. An optical coupler according to claim 4, wherein the optical fiber splice includes a fusion splice between the step index optical fiber and the graded index optical fiber.

6. An optical coupler according to claim 4, wherein the optical fiber splice includes a mechanical splice between the step index optical fiber and the graded index optical fiber.

7. An optical coupler according to claim 6, wherein the mechanical splice includes a mated plug assembly between the step index optical fiber and the graded index optical fiber.

8. An optical coupler according to claim 7, wherein the mated plug assembly includes mated LC type optical connectors.

9. An optical coupler according to claim 1, wherein the first output includes a step index optical fiber.

10. An optical coupler according to claim 1, wherein the second output includes a step index optical fiber.

11. An optical coupler according to claim 1, wherein the optical coupler is associated with a predetermined split ratio.

12. An optical coupler according to claim 11, wherein the split ratio is between about 10:90 and 50:50.

13. An optical coupler according to claim 11, wherein the split ratio is about 20:80.

14. An optical coupler according to claim 11, wherein the split ratio is about 30:70.

15. An optical coupler according to claim 2, wherein a length of the step index optical fiber is at least about 2 centimeters.

16. An optical coupler according to claim 2, wherein a length of the step index optical fiber is between about 5 centimeters and about 100 centimeters.

17. An optical coupler according to claim 2, wherein a length of the step index optical fiber is between about 10 centimeters and about 20 centimeters.

18. An optical coupler according to claim 2, wherein a core diameter of the step index optical fiber is between about 25 and about 200 micron.

19. An optical coupler according to claim 2, wherein a core diameter of the step index optical fiber is about 50 micron.

20. An optical coupler according to claim 2, wherein a core diameter of the step index optical fiber is about 62.5 micron.

21. An optical coupler according to claim 1, wherein the first output includes a first output optical fiber, the second output includes a second output optical fiber, and the input includes an input optical fiber.

22. An optical coupler according to claim 1, wherein the means for introducing mode-mixing includes an attenuation device, surface coating, surface treatment, mechanical or optical perturbation, a doped fiber, or a roughness to a surface.

23. A Fibre Channel tap comprising the optical coupler according to claim 1.

24. A Fibre Channel tap comprising at least two optical couplers according to claim 1 and configured to support up to 10 gigabits-per-second.

25. A Fibre Channel tap comprising between about four and about 32 optical couplers according to claim 1.

26. A system comprising:
an optical coupler comprising:
an input;
means for introducing mode-mixing optically coupled to the input;
a first output;
a second output; and
a fiber optic splitter configured to optically couple the input with the first output and the second output;
a first electronic device optically coupled to the input of the optical coupler; and
a second electronic device optically coupled to the second output of the optical coupler.

27. A system according to claim 26, wherein the means for introducing mode-mixing includes a step index fiber.

28. A system according to claim 26, wherein the first electronic device includes a network host device and the second electronic device includes a network switch device.

29. A system according to claim 26, further comprising an analysis device coupled to the first output, the analysis device being configured to monitor and/or analyze data transmitted from the first electronic device to the second electronic device.

30. A system according to claim 29, wherein the analysis device includes a probe configured to monitor and/or analyze data transmitted from the first electronic device to the second electronic device at line rates of at least 4 gigabits-per-second.

31. A method for processing an optical signal transmitted in an optical communication link, the method comprising:
introducing mode-mixing to the optical signal; and
diverting a portion of the optical signal transmitted in the optical communication link.

32. A method according to claim 31, wherein the diverted portion of the optical signal has a waveform that substantially represents a waveform of the optical signal transmitted in the optical communication link.

33. A method according to claim 31, further comprising:
converting the diverted portion of the optical signal to an electrical signal; and
outputting the electrical signal to an electronic device.

34. A method according to claim 31, wherein the optical signal transmitted in the optical communication link is associated with a transmission rate of at least about 4 gigabits-per-second.

35. A method for analyzing an optical signal, comprising:
performing the acts of claim 31; and
analyzing the diverted portion of the optical signal.

36. A method according to claim 35, wherein the received optical data is analyzed for a mask margin associated with the received optical data.

37. A method according to claim 36, wherein the mask margin includes less than 5 percent mask degradation.

38. A method according to claim 35, wherein the analysis includes analysis of a network within which the optical data is transmitted.
